(19) United States
(12) Patent Application Publication
(10) Pub. No.: US 2014/0361615 A1
(43) Pub. Date: Dec. 11, 2014

(54) ELECTRONIC DEVICE WITH FORCED SHUTDOWN FUNCTION

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: TAO WANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/951,408

(22) Filed: Jul. 25, 2013

(30) Foreign Application Priority Data
Jun. 5, 2013 (CN) 2013102211290

(51) Int. Cl. H02J 4/00

(52) U.S. Cl. CPC H02J 4/00
USPC 307/23

(57) ABSTRACT

An electronic device includes an built-in battery unit, a voltage converter, a resistor, and a mechanical button. When the electronic device is connected to an external power source, the external power source provides power to the voltage converter and charges the built-in battery unit. When the external power source is absent, the built-in battery unit provides power to the voltage converter. A first end of the resistor is connected to an enable pin of the voltage converter, and a second end is connected to the button. When the electronic device is not connected to the external power source, and the button is moved a position to cause the second end of the resistor to be grounded, the voltage at the enable pin of the voltage converter goes to be logic low, the voltage converter is disabled, forcing shut down of the electronic device.

### BACKGROUND

1. Technical Field

The present disclosure relates to electronic devices, and particularly to an electronic device with a forced shutdown function.

2. Description of Related Art

Batteries of some portable electronic devices are built-in and not meant to be removed. When such an electronic device is connected to an external power source, the external power source not only provides power to the electronic device, but also charges the built-in batteries. Referring to FIG. 2, an electronic device 100 includes a power source interface 11, a switch 12, a charging and recharging protection unit 13, an built-in battery unit 14, a voltage converter 15, and electronic components 16. The power source interface 11 is used to connect the electronic device 100 to an external power source. The power source interface 11 is connected to the built-in battery unit 14 via the switch 12 and the charging and recharging protection unit 13. The switch 12 includes two diodes in reverse parallel connection. A voltage input pin Vin and an enable pin En of the voltage converter 15 is connected to the power source interface 11 and the switch 12. The voltage converter 15 converts the voltage provided by the external power source to a work voltage of the electronic components 16. When the voltage at the enable pin En is logic high, the voltage converter 15 works. When the power source interface 11 is not connected to the external power source, the built-in battery unit 14 provides power to the voltage converter 15. With such configuration, if the electronic device 100 crashes, even if the connection between the electronic device 100 and the external power source is cut off, the electronic device 100 cannot shut down because the built-in battery unit 14 will still provide power to the electronic device, which may damage the electronic device 100.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a circuit diagram of an electronic device with a forced shutdown function, in accordance with an exemplary embodiment.

FIG. 2 is a circuit diagram of a known electronic device.

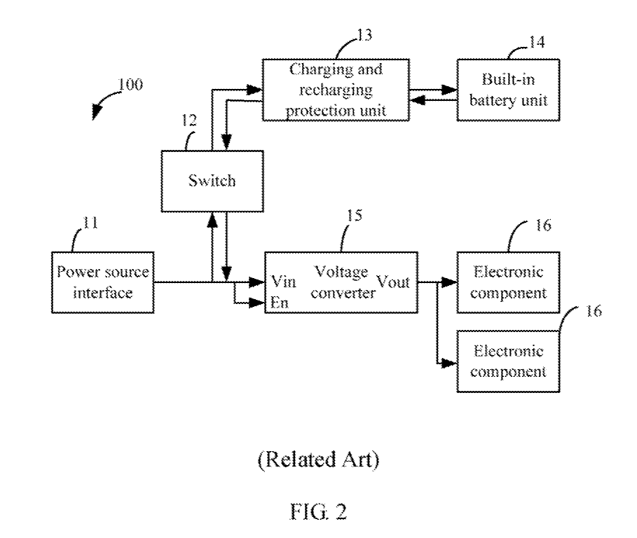

### DETAILED DESCRIPTION

Embodiments of the present disclosure will now be described in detail, with reference to the accompanying drawings.

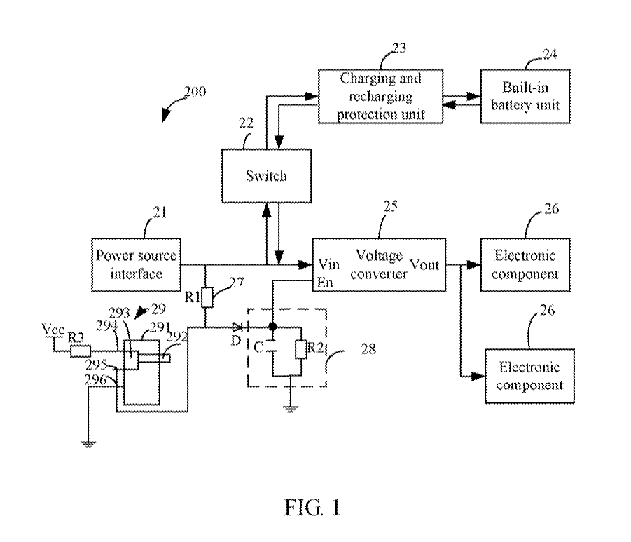

FIG. 1 shows an embodiment of an electronic device 200. The electronic device 200 includes a power source interface 21, a switch 22, a charging and recharging protection unit 23, a built-in battery unit 24, a voltage converter 25, electronic components 26 connected to the voltage converter 25, a resistor 27, a RC parallel circuit 28, and a mechanical button 29. The power source interface 21 is used to connect the electronic device 200 to an external power source. The power source interface 21 is connected to the built-in battery unit 24 via the switch 22 and the charging and recharging protection unit 23. A voltage input pin of the voltage converter 25 is connected between the power source interface 21 and the switch 22. When the power source interface 21 is connected to an external power source, the switch 22 is turned on in a first direction, such that the external power source charges the built-in battery unit 24 and provides power to the voltage converter 25. When the power source interface 21 is in an idle state, the switch 22 is on in a second direction opposite to the first direction, such that the built-in battery unit 24 provides power to the voltage converter 25. The first switch 22 may include two diodes in reverse parallel connection. The voltage converter 25 converts the power provided by the external power source or the built-in battery unit 24 to a work voltage of the electronic components 26. When the voltage at an enable pin of the voltage converter 25 is logic high, the voltage converter 25 works. When the voltage at the enable pin is logic low, the voltage converter 25 is disabled.

A first terminal of the resistor 27 is connected between the power source interface 21 and the voltage input pin of the voltage converter 25. A second terminal of the resistor 27 is connected between the mechanical button 29 and the RC parallel circuit 28. In this embodiment, the second terminal of the resistor 27 is connected to the RC parallel circuit via a diode D. The anode of the diode D is connected to the second terminal of the resistor 27, and the cathode of the diode D is connected to a first terminal of the RC parallel circuit 28. The first terminal of the RC parallel circuit 28 is further connected to the enable pin of the voltage converter 25. A second terminal of the RC parallel circuit 28 is grounded.

In this embodiment, the mechanical button 29 is moved between a first position and a second position. When the mechanical button 29 is in the first position, the second terminal of the resistor 27 is connected to a power source Vcc. When the mechanical button 29 is in the second position, the second terminal of the resistor 27 is grounded. Specifically, the mechanical button 29 includes an insulated main body 291, an operable portion 292 slidably received in the main body 291, a conductive contact portion 293 secured to an end of the operable portion 292, a first conductive terminal 294, a second conductive terminal 295, and a third conductive terminal 296. All of the terminals 294, 295, and 296 are spaced apart from each other and arranged on the main body 291. The first conductive terminal 294 is connected to the power source Vcc via a resistor R3. The second conductive terminal 295 is connected to the second terminal of the resistor 27. The third conductive terminal 296 is grounded. The distance between the first conductive terminal 294 and the second conductive terminal 295 is the same as the distance between the second conductive terminal 295 and the third conductive terminal 296. The conductive portion 293 can contact the first conductive terminal 294 and the second conductive terminal 295 at the same time, or contact the second conductive terminal 295 and the third conductive terminal 296 at the same time. When the operable portion 292 is slid to cause the mechanical button 29 to be in the first position, the conductive portion 293 contacts the first conductive terminal 294 and the second conductive terminal 295 at the same time. When the operable portion 292 is slid to cause the mechanical button 29 to be in the second position, the conductive portion 293 contacts the second conductive terminal 295 and the third conductive terminal 296 at the same time. In this embodiment, at least a portion of the conductive portion 293 is made of magnetic material. Thus, when the mechanical button 29 is released, the attraction among the conductive portion 293, the first conductive terminal 294, and the second conductive terminal 295, or the attraction among the conductive portion 293, the second conductive terminal 295, and the third conductive terminal 296 can cause the mechanical button 29 to remain in the first position or the second position.

In this embodiment, when the power source interface 21 is connected to an external power source, and the mechanical button 29 is slid to the first position, the external power source charges the built-in battery unit 24 and provides power to the voltage converter 25. The voltage at the enable pin En is logic high, thus the voltage converter 25 works. The external power source further charges a capacitor C of the RC parallel circuit 28. If the electronic device 200 crashes, the connection between the electronic device 200 and the external power source is cut off, and the mechanical button 29 is slid to the second position. At this point, as the resistor 27 is grounded, the built-in battery unit 23 cannot provide power to the RC parallel circuit 28, and the capacitor C discharges. While the capacitor C discharges, the voltage at the enable pin En is still logic high, thus the voltage converter 25 still works to convert the power provided by the built-in battery unit 23 to the work voltage of the electronic components 26. When the capacitor C fully discharges, the voltage at the enable pin En is changed to be logic low, the voltage converter 25 is disabled, thus the electronic components 26 are disabled, and the electronic device 200 is shut down.

With such configuration, when the electronic device 200 cannot be normally shut down, the mechanical button 29 can be used to force shut down of the electronic device 200.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device with a forced shutdown function, comprising:
a switch;
a charging and recharging protection unit;
a built-in battery unit;
a voltage converter comprising a voltage input pin and an enable pin both connected to the switch, wherein, when the voltage at the enable pin is logic high, the voltage converter works, and when the voltage at the enable pin is logic low, the voltage converter is disabled;
a power source interface to connect the electronic device to an external power source, wherein, the power source interface is connected to the built-in battery unit via the switch and the charging and recharging unit, and is further connected to the voltage input pin and the enable pin of the voltage converter, when the power source interface is connected to the external power source, the switch is turned on in a first direction, and the external power source charges the built-in battery unit and provides power to the voltage converter, when the power source interface is in an idle state, the switch is turned on in a second direction opposite to the first direction, such that the built-in battery unit provides power to the voltage converter;
a plurality of electronic components connected to the voltage converter, wherein, the voltage converter converts the power provided by the external power source or the built-in battery unit to a work voltage of the electronic components;
a RC parallel circuit with a first end connected to the enable pin of the voltage converter and a second end grounded; and
a resistor comprising a first end and a second end, wherein the first end of the resistor is connected to the power source interface and the voltage input pin of the voltage converter, the second end of the resistor is connected to a mechanical button and the RC parallel circuit;
wherein, the mechanical button is moved between a first position and a second position, when the mechanical button is in the first position, the second end of the resistor is connected to a power source Vcc, and when the mechanical button is in the second position, the second end of the resistor is grounded.

2. The electronic device as described in claim 1, further comprising a diode, wherein the anode of the diode is connected to the second end of the resistor, and the cathode of the diode is connected to the first end of the RC parallel circuit.

3. The electronic device as described in claim 1, wherein the mechanical button comprises an insulated main body, an operable portion slidably received in the main body, a conductive contact portion secured to an end of the operable portion, and a first conductive terminal, a second conductive terminal, and a third conductive terminal, the first conductive terminal, the second conductive terminal, and the third conductive terminal are spaced apart from each other and arranged on the main body, the first conductive terminal is connected to the power source Vcc, the second terminal is connected to the second end of the resistor, and the third terminal is grounded, when the operable portion is slid to cause the mechanical button to be in the first position, the conductive contact portion contacts the first terminal and the second terminal at the same time, and when the operable portion is slid to cause the mechanical button to be in the second position, the conductive contact portion contacts the second terminal and the third terminal at the same time.

4. The electronic device as described in claim 3, wherein the distance between the first conductive terminal and the second conductive terminal is the same as the distance between the second conductive terminal and the third conductive terminal

5. The electronic device as described in claim 1, wherein at least a portion of the conductive contact portion is made of magnetic material.
